(19) United States
(12) Patent Application Publication
(10) Pub. No.: US 2009/0271094 A1
(43) Pub. Date: Oct. 29, 2009

(54) ENGINE WITH CHARGE AIR RECIRCULATION AND METHOD

(75) Inventors: Mark Stablein, Hagerstown, MD (US); Axel Radermacher, Frederick, MD (US)

Correspondence Address: WRB-IP LLP, 1217 KING STREET, ALEXANDRIA, VA, 22314, US

(73) Assignee: Mack Trucks, Inc., Allentown, PA (US)

(21) Appl. No.: 12/441,699

(22) PCT Filed: Oct. 2, 2006
(86) PCT No.: PCT/US06/38245

§ 371 Date: Mar. 17, 2009

(51) Int. Cl. F02D 43/00; F02B 33/44; F02D 23/00

(52) U.S. Cl. 701/108; 60/605.2; 60/600

(57) ABSTRACT

An engine comprises an intake and an exhaust, a compressor having an inlet and an outlet, a conduit between the compressor outlet and the engine intake, a recirculation conduit between the compressor outlet and the compressor inlet, and a valve for controlling flow through the recirculation conduit. A method for controlling an engine and a compressed gas are also disclosed.

### BACKGROUND AND SUMMARY

The present invention relates to engines and, more particularly, to engines with charge air recirculation and to methods relating to such engines.

As explained in International Application No. PCT/US2006/001231, filed Jan. 13, 2006, entitled ENGINE WITH EXHAUST TEMPERATURE CONTROL AND METHOD OF CONTROLLING ENGINE EXHAUST GAS TEMPERATURE AND ENGINE INTAKE TEMPERATURE, which is incorporated by reference, stringent emissions regulations such as those imposed by U.S. and European regulatory officials, have progressively reduced the amount of diesel particulate matter (DPM) and other gaseous constituents allowed in the exhaust gases of diesel engines. The emissions levels proposed by the US07 and Euro 5 regulations are so low that they cannot be met without the use of exhaust aftertreatment devices. Diesel particulate filtration devices (DPF) and Diesel Oxidation Catalysts (DOC) are examples of devices which may be used to comply with particulate emissions levels.

DPFs filter the particulate matter from the exhaust gases to prevent them from exiting the tailpipe. After a period of operation, the collected particulates start to clog the filter. The filter either needs to be replaced or removed for cleaning, which is not practical, or it needs to clean itself through a process known as regeneration. DPM is made up primarily of carbon, and is therefore combustible. Regeneration is a process where temperatures of the exhaust gases are high enough to combust the DPM within the filter.

When engines are operated under higher loads the exhaust gas temperatures are generally high enough to regenerate without assistance. However, during light or highly cyclic loads, or when ambient temperatures are low, the temperature of the exhaust gas is not high enough to produce regeneration. During these periods it is necessary to actively raise the exhaust gas temperature to facilitate regeneration or to increase exhaust gas temperatures to facilitate operation of other exhaust aftertreatment devices.

Various techniques are known for providing regeneration assistance. For example, it is known to use a resistive electric heating element directly in the exhaust stream to increase exhaust gas temperature. It is also known to inject fuel into the exhaust and combust the fuel in a dedicated burner assembly to raise exhaust gas temperature. It is also known to inject a hydrocarbon into the exhaust gas and use a catalytic device that elevates exhaust gas temperature by catalytically oxidizing the injected hydrocarbon. An exhaust gas restriction device that applies an engine retarding load (braking load) to the engine can also be used to cause it to run at an elevated engine load condition, thus elevating the exhaust gas temperature. It is also known to elevate diesel particulate matter (DPM) temperatures by using microwaves.

It is desirable to provide an arrangement and a method for adjusting the temperature of engine exhaust, particularly when the engine is operated at low loads.

It is desirable to provide an arrangement and a method for adjusting the temperature of engine intake gas.

It is desirable to provide an arrangement and a method for adjusting the temperature of engine intake and exhaust gases as a means of accelerating engine warm-up at start-up and to maintain elevated engine temperatures during extended idling.

While emissions can be controlled through the use of DPFs, other techniques for controlling emissions, and for controlling engines, generally, include adjusting an air-fuel ratio at the engine intake and utilizing exhaust gas recirculation (EGR). It is desirable to provide an engine, the operation of which is adapted to be controlled, particularly with respect to production of engine emissions.

According to an aspect of the present invention, an engine comprises an engine having an intake and an exhaust, a compressor having an inlet and an outlet, a conduit between the compressor outlet and the engine intake, a recirculation conduit between the compressor outlet and the compressor inlet, and a valve for controlling flow through the recirculation conduit.

According to a further aspect of the present invention, a method for controlling an engine comprises compressing charge air in a compressor, recirculating compressed gas from an outlet of the compressor to an inlet of the compressor such that the compressed gas from the outlet of the compressor comprises a mixture of charge air and recirculated compressed gas, opening and closing a valve to control recirculation of the compressed gas, and supplying the compressed gas to an engine intake.

According to another aspect of the present invention, a compressed gas for an engine intake comprises compressed fresh charge air that has been compressed in a compressor, and recirculated compressed charge air that is recirculated after compression in the compressor to an inlet of the compressor.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic view of an engine according to an embodiment of the present invention.

### DETAILED DESCRIPTION

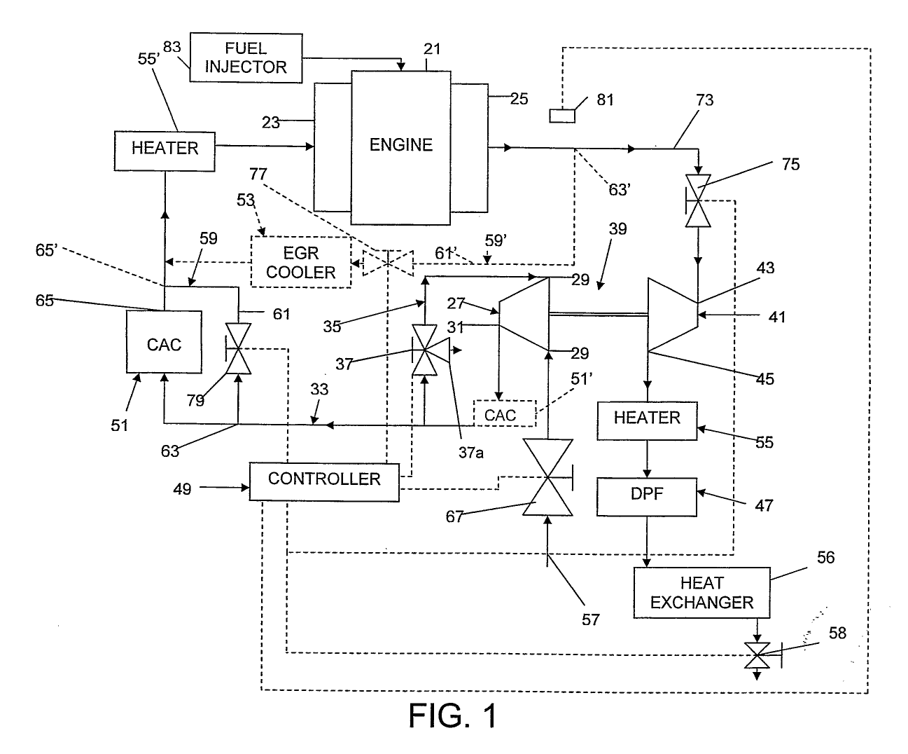

An engine 21 having a control arrangement is shown in FIG. 1. The engine 21 has an intake 23 and an exhaust 25. Typically, the intake 23 and the exhaust 25 will be in the form of intake and exhaust manifolds. The engine 21 can be any desired type of engine, however, the present invention is presently contemplated as having particular application in connection with diesel engines.

A compressor 27 is provided and has an inlet 29 and an outlet 31. A charge air intake 57 is connected to the compressor inlet 29. A conduit 33 is provided between the compressor outlet 31 and the engine intake 23. A recirculation conduit 35 is provided between the compressor outlet 31 and the compressor inlet 29. A valve 37 is provided for controlling flow through the recirculation conduit 35.

The compressor 27 is ordinarily part of a turbocharger, or mechanically driven supercharger, 39 comprising the compressor. Other compressors 27 can include centrifugal compressors or positive displacement pumps, which may be components of superchargers. For purposes of illustration, an embodiment comprising a turbocharger shall be described. The turbocharger 39 can comprise a turbine 41 having an inlet 43 and an outlet 45. The engine exhaust 25 can be connected to the turbine inlet 43, the turbine 41 can be driven by exhaust gas from the engine exhaust, and the turbine can drive the compressor 27.

The temperature of the exhaust gas exiting the engine 21 is directly related to the amount of fuel burned, the amount of combustion air and the inlet temperature of the combustion air when it is introduced to the engine. In the engine 21 having a control arrangement, air that has already been compressed by the turbocharger's 39 compressor 27 is recirculated back into the compressor inlet 29. The gas flow can be controlled using the valve 37, such as to limit recirculation to those times when it is desirable to actively increase exhaust gas temperatures. The valve 37 can be used adjust emissions at the engine exhaust 25, and to adjust the air-fuel ratio at the engine intake 23.

By recirculating a portion of the inlet air repeatedly through the compressor 27 the temperature of the inlet air to the engine can be increased significantly. Additionally, the overall mass flow of inlet air being delivered to the engine 21 can be reduced because part of the total mass flow through the compressor 27 is being recirculated which can affect the air-fuel ratio and, consequently, engine emissions characteristics. Additionally, reducing mass flow of inlet air facilitates introduction of more EGR to the engine intake because pressure at the intake due to inlet air is reduced. Also, because pressure at the intake 23 due to inlet air is reduced, the pressure of the exhaust gas can be reduced yet still permit flow of EGR to the intake. Further, the amount of work required to power the turbocharger's or supercharger's 39 compressor will be increased to deliver a given mass flow of fresh air to the engine, thus allowing more fuel to be burned for a given engine operating condition and resulting in an increase in engine exhaust temperature. An exhaust gas aftertreatment device 47 can be disposed downstream of the turbine 41 and can be operated at an elevated exhaust gas temperature by exhaust gas entering the exhaust gas aftertreatment device at an elevated temperature, i.e., elevated relative to the temperature at which the exhaust gas would enter the aftertreatment device in the absence of recycling through the recirculation conduit 35 or other heating of the exhaust gas. While the aftertreatment device 47 is shown as a diesel particulate filter DPF in FIG. 1, any number of aftertreatment devices can be provided instead of or in addition to a DPF. For example, the exhaust gas aftertreatment device 47 can include a diesel oxidation catalyst and/or a diesel NOx catalyst. The exhaust gas aftertreatment device 47 can be of a type that is adapted to be regenerated by exhaust gas entering the exhaust gas aftertreatment device at an elevated temperature, such as a temperature at which regeneration of the exhaust gas aftertreatment device can occur, such as is the case with devices such as DPFs, devices including diesel oxidation catalysts, and devices including diesel NOx catalysts.

A controller 49 can be provided to control opening and closing of the valve 37 to control a temperature of the exhaust gas, such as by raising it to a temperature sufficient for regeneration or increased effectiveness of the aftertreatment device 47. It will be appreciated that references to “opening and closing” of valves encompasses opening and closing valves to less than fully open and less than. fully closed as desired. The valves described here can be on/off type valves or valves that are capable of modulation to any number of positions between completely open and completely closed.

While described here in connection with adjustment of the temperature of the engine exhaust gas, adjustment of air-fuel ratio at the engine intake 23, and adjustment of emissions characteristics at the engine exhaust 25, it will be appreciated that opening and closing of the valve 37 can be directed to adjusting other characteristics of the engine. For example, opening and closing of the valve 37 can be directed to adjusting the temperature of gas at the intake 23 of the engine 21, such as to facilitate warming of the engine in cold weather or to maintain a gas above its dew point within the engine's inlet and exhaust systems, or an exhaust gas recirculation (EGR) cooler 53 to prevent potentially harmful condensation. When the temperature of gas entering the engine intake is adjusted, it follows that the temperature of gas exiting the engine exhaust will be adjusted, as well. In addition to facilitating adjusting the exhaust gas temperature, the arrangement according to the present invention may also be adapted to facilitate elevating combustion and exhaust gas temperatures during engine start-up to reduce hydrocarbon exhaust gas emissions during cold starting, and may be used to maintain the engine in a warm condition, such as by periodically cycling the arrangement on and off to maintain at least a minimal desired engine temperature, and/or to provide cab heating, such as by providing suitable heat exchangers 56 proximate the intake or the exhaust to take advantage of the elevated temperatures, and/or to optimize combustion, such as by operation at an optimal engine temperature. Temperature monitors (not shown) can be provided on the engine and/or a space such as a vehicle cab associated with the engine. The temperature monitors can send signals to the controller 49 to open or close the valve 37 to adjust the engine temperature or the temperature in the space.

To facilitate heating of the exhaust gas prior to the aftertreatment device 47, one or more supplemental exhaust gas heating assemblies 55, operable together with the controller 49, can be provided for heating exhaust gas downstream of the turbine 41 to an elevated exhaust gas temperature, such as a temperature at which regeneration of the aftertreatment device can occur. The supplemental exhaust gas heating assembly 55 can comprise one or more of a resistive heating element in the exhaust gas stream; a burner arrangement for injecting fuel into the exhaust gas stream and combusting it in a dedicated burner assembly; a catalytic device, a hydrocarbon source, and a hydrocarbon injector, the catalytic device elevating exhaust gas stream temperatures by catalytically oxidizing injected hydrocarbon; an exhaust gas restriction device for applying an engine retarding load to cause the engine to run at an elevated load condition such that an exhaust gas stream having an elevated temperature is produced; and a microwave arrangement. Of course, the controller 49 may be operated to control opening and closing of the valve 37 to raise the temperature of the exhaust gas to an elevated temperature such as the regeneration temperature without also using supplemental exhaust gas heating assemblies.

Another benefit of the recirculation system including the valve 37 and the recirculation conduit 35 is that the system can reduce boost pressure, thereby reducing air flow through the engine 21. Reduced air flow through the engine 21 directly increases the exhaust temperature. Thus, in addition to increasing exhaust temperature by recirculating intake air to heat the air, recirculating intake air reduces the boost pressure and can increase exhaust temperature in this manner, as well. Boost pressure of intake air can also be decreased by venting some of the intake air downstream of the compressor 27, such as through a vent 37a in the recirculation conduit 35.

The turbine of a turbocharger can function as an exhaust gas restriction device, as can auxiliary devices 58 such as an exhaust pressure governor or other commercially available devices, such as valves. In addition, if the supercharger is a variable geometry turbocharger (VGT) of the type having adjustable, openable and closable vanes, then, for most of its operating range, when the VGT vanes are closed, the turbine creates a restriction in the exhaust line yet it increases air flow through the engine and thereby reduces exhaust temperature. However, at some very small openings, one can operate in a condition where the VGT chokes flow and effectively raises exhaust temperatures, but this is difficult to control. By including the recirculation system including the recirculation conduit 35 and the valve 37 (and the vent 37a) the VGT can be closed down and no additional boost is created. This allows the VGT to operate as a restrictive device in a stable, controllable manner by increasing load/pressure at the exhaust and by decreasing air flow at the intake by decreasing boost pressure.

In additional to or instead of providing one or more supplemental exhaust gas heating assemblies 55, temperatures of the inlet gas and the exhaust gas can be adjusted by one or more supplemental inlet gas heating assemblies 55′. Supplemental inlet gas heating assemblies 55′ may include, by way of illustration, arrangements such as are used for the supplemental exhaust gas heating assemblies 55.

The CAC 51 can be provided in the conduit 33 and the controller 49 can be adapted to control opening and closing of the valve 37 to control a temperature of gas exiting the charge air cooler. Further control of gas temperature downstream of the CAC 51 can be provided by providing a charge air cooler bypass arrangement 59. The charge air cooler bypass arrangement 59 can comprise a line 61 connected to the conduit 33 at points 63 and 65 upstream and downstream, respectively, from the CAC 51.

While the CAC 51 is shown disposed downstream of the recirculation conduit 35 and valve 37, the CAC 51′ (shown in phantom) can be disposed upstream of the recirculation conduit 35 and valve 37. A CAC bypass (not shown) can be provided for the CAC 51′. If the valve 37 is mounted directly after the compressor 27 discharge, then it is possible that the compressor discharge temperature could exceed the valve's safe operating range. If air that is cooler than the compressor discharge air flows through the valve 37, such as air after the CAC, then the likelihood of exceeding permissible temperatures in the valve 37 can be reduced or eliminated. In addition, a valve through which cooler air flows can be smaller while still providing the same mass flow rate. The system could also be constructed of cheaper materials since operating temperatures are lower. Also, if the air were vented to atmosphere, cooler air would avoid heating components in the vicinity of the exit. Further, locating the recirculation conduit 35 and valve 37 after the CAC 51′ can reduce CAC effectiveness.

An alternative, or additional, charge air cooler bypass arrangement 59′ comprises an EGR line 61′ connected at a point 63′ to the engine exhaust 25 and connected to the conduit 33 at a point 65′ downstream from the CAC 51. The EGR line 61′ can include an EGR cooler 53. In addition, the CAC bypass arrangement 59 can be omitted and the CAC can be bypassed by a connection (not shown) from the conduit 33 upstream of the CAC to the EGR line 61′, either upstream or downstream from the EGR cooler 53.

The recirculation conduit 35 can be integral with the compressor 27, such as being formed as part of the compressor. Alternatively, the recirculation conduit 35 can be external to the compressor, such as by being comprised of conduits such as hoses, pipes, etc. connected to the compressor or to conduits connected to the compressor. The recirculation conduit 35 can, in addition, be partially integral with the compressor 27 and partially external to the compressor.

A method aspect of the present invention for controlling engine exhaust gas temperature shall be described with reference to FIG. 1. According to the method, charge air from the charge air intake 57 is compressed in a compressor 27. Compressed gas is recirculated from an outlet 31 of the compressor 27 to an inlet 29 of the compressor such that compressed gas from the outlet of the compressor comprises a mixture of charge air and recirculated compressed gas. In this way, obtaining a desired temperature of the compressed gas can be facilitated.

The compressed gas is supplied to an engine intake 23. A CAC 51 can be provided and at least some of the compressed gas can be passed through the CAC upstream of the engine intake 23. Additionally, a CAC bypass 59 can be provided between the outlet 31 of the compressor 27 and the engine intake 23 and some of the compressed gas can be passed through the CAC bypass. Passing some compressed gas through the CAC 51 and some compressed gas through the CAC bypass 59 can facilitate obtaining a desired temperature for the gas at the intake 23 of the engine 21.

The compressor 27 can be a compressor of a turbocharger 39 that comprises a turbine 41. The engine exhaust gas can flow to the turbine 41 to drive the turbine which, in turn, can drive the compressor 27.

The controller 49 can control a ratio of charge air and recirculated compressed gas in the compressor 27, such as by controlling opening and closing of valves 67 and 37 in the charge air intake 57 and the recirculation conduit 35, respectively. To the extent that other adjustments in flow through various lines is necessary, all of the lines can be provided with valves that can be controlled by the controller 49. For example, the line 73 between the exhaust 25 and the turbine inlet 43 can include a controllable valve 75, the EGR line 61′ can include a controllable valve 77, the CAC bypass line 61 can include a controllable valve 79, and other lines can include other controllable valves (not shown).

Another method aspect of the present invention for controlling engine intake gas temperature shall be described in connection with FIG. 1. According to the method, compressed gas from an outlet 31 of a compressor 27 is divided so that at least a first portion of the compressed gas is recirculated through a recirculation conduit 35 to an inlet 29 of the compressor and at least a second portion of the compressed gas flows to an engine intake 23. The recirculated compressed gas and charge air from a charge air intake 57 are compressed in the compressor 27. A ratio of the first portion and the second portion of the compressed gas is controlled, such as by controlling opening and closing of the valve 37 in the recirculation conduit 35 by the controller 49.

A valve (not shown) can be provided in the conduit 33 for controlling the ratio of the first portion and the second portion of the compressed gas together with the valve 37 or by itself. A ratio of the recirculated compressed gas and the charge air can also be controlled by the controller 49, such as by controlling opening and closing of the valve 37 in the recirculation conduit 35 and the valve 67 in the charge air intake 57. It will be appreciated that opening and closing any of the valves 37, 67, 75, 77, and 79 can affect the ratio. One or more of the valves can also be controlled by the controller 49 to control a ratio of the recirculated compressed gas and the charge air at the inlet 29 of the compressor 27. Valves, particularly a valve in the conduit 33, can also be used to create a restriction such that the amount of work needed by the engine to deliver a given mass flow of inlet air is increased.

At least some exhaust gas from the exhaust 25 of the engine 21 can be recirculated to the engine intake 23, such as through the EGR line 61′. The recirculated exhaust gas can be cooled in an exhaust gas recirculation cooler 53. In addition, at least some of the second portion of the compressed gas can be cooled in the CAC 51. The CAC can be bypassed with at least some of the second portion of the compressed gas.

While the invention has thus far largely been described in connection with an aspect wherein exhaust or intake temperature is adjusted, in a fundamental aspect of the invention, the engine 21 can be adapted to control a variety of engine characteristics, not limited to exhaust or intake temperatures. According to a basic aspect of the engine 21, the engine comprises an intake 23 and an exhaust 25, a compressor 27 having an inlet 29 and an outlet 31, a conduit 33 between the compressor outlet and the engine intake, and a recirculation conduit 35 between the compressor outlet and the compressor inlet. A valve 37 is provided for controlling flow through the recirculation conduit 35.

The controller 49 can be arranged to control opening and closing of the valve 37 to adjust emissions characteristics at the engine exhaust 25. A monitor 81 for monitoring emissions characteristics can be provided at or proximate the engine exhaust 25. The monitor can be arranged to send a signal to the controller 49 to open and close the valve 37 to adjust emissions characteristics. At the same time, the monitor 81 can send a signal to the controller to open and close the valve 37 and the EGR valve 77 to adjust emissions characteristics. Similarly, other valves discussed herein can be opened and closed to adjust emissions characteristics in response to a signal from the monitor 81 to the controller 49, such as the CAC bypass valve 79, and the valve 75 in the exhaust line 73. It will be appreciated that adjustment of the various valves provided with the engine 21, together with adjustment of the recirculation vale 37, will permit substantial flexibility in adjusting characteristics such as exhaust and intake temperature, engine emissions, and air-fuel ratio. It will further be appreciated that monitoring devices (not shown) in addition to the monitor 81 for emissions can be provided throughout the engine and valves including the recirculation valve 37 can be adjusted in response to signals from those monitors.

The engine 21 ordinarily includes a fuel injector 83 arranged to inject fuel at the cylinders. The controller 49 can be arranged to control opening and closing of the recirculation valve 37 to adjust the air-fuel ratio at the engine intake. The emissions monitor 81 can, at the same time, send signals to the controller to open and close the valve 37 to adjust emissions characteristics. The monitor 81 can also send a signal to the controller 49 to open and close the valve 37 together with the EGR valve 77 to adjust emissions characteristics.

In a further aspect of the present invention, the controller 49 can be arranged to control opening and closing of the valve 37 to adjust an air-fuel ratio. By appropriate adjustment of the air-fuel ratio, the engine can be caused to operate lean, as is typical in diesel engines, or rich, or somewhere in between. When the engine is operated rich, some unburned portion of the fuel remains in the exhaust. The unburned fuel can be used to regenerate aftertreatment equipment such as the DPF.

In a general method for controlling the engine 21 charge air is compressed in the compressor 27 and compressed gas from the outlet 31 of the compressor is recirculated to the inlet 29 of the compressor such that the compressed gas from the outlet of the compressor comprises a mixture of charge air and recirculated compressed gas. The recirculation through the recirculation line 35 is controlled by opening and closing the recirculation valve 37. The compressed gas is supplied to the engine intake. By adjusting the recirculation valve 37, the ratio of charge air and recirculated compressed gas in the compressor can be adjusted.

Emissions characteristics at the exhaust of the engine 21 can be adjusted by controlling recirculation of the compressed gas. Emissions characteristics can also be adjusted by controlling EGR flow through the EGR line 61′ to the engine intake 23, such as by opening and closing the EGR valve 77, either alone or in combination with adjustment of the recirculation valve 37.

The method can also include injecting fuel into the engine cylinders with a fuel injector 83 and adjusting an air-fuel ratio at the intake by controlling recirculation of the compressed gas, such as by adjusting the valve 37. The air-fuel ratio can also be adjusted in other ways, such as by controlling EGR flow through the EGR line 61′ to the engine intake 23 by, for example, adjusting the EGR valve 77.

Characteristics such as air-fuel ratio, exhaust gas temperature, and emissions characteristics can be adjusted through control of recirculation of compressed gas through appropriate adjustment of the valve 37 in combination with other adjustments. For example, adjustment of a casing size of a turbine portion of a variable geometry turbocharger can permit adjustment of, for example, EGR boost pressure, which can be achieved substantially independent of adjustment of inlet air pressure. The valve 37 provides another means of adjusting inlet air pressure to control an amount of EGR gas. The valve 37 can also be used to control an amount of EGR gas regardless whether the turbocharger and turbine are part of a VGT. For example, exhaust pressure and EGR pressure can be adjusted with one or more valves 75 and 77, respectively, and inlet air pressure can be adjusted using the valve 37.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

1. An engine, comprising:
an engine having an intake and an exhaust, a compressor having an inlet and an outlet;
a conduit between the compressor outlet and the engine intake;
a recirculation conduit between the compressor outlet and the compressor inlet;
a valve for controlling flow through the recirculation conduit;
a controller arranged to control opening and closing of the valve to adjust emissions characteristics at the engine exhaust; and
a monitor for monitoring emissions characteristics and sending a signal to the controller to open and close the valve to adjust emissions characteristics.

2. The engine as set forth in claim 1, comprising a supercharger comprising the compressor.

3. The engine as set forth in claim 2, wherein the supercharger comprises a turbocharger.

4. The engine as set forth in claim 3, wherein the turbocharger comprises a turbine having an inlet and an outlet, the engine exhaust being connected to the turbine inlet and the turbine being driven by exhaust gas from the engine exhaust, the turbine driving the compressor.

5. The engine as set forth in claim 3, comprising a variable geometry turbocharger adapted to increase exhaust pressure and decrease compressor boost.

6. The engine as set forth in claim 1, comprising a vent downstream of the compressor outlet.

7. The engine as set forth in claim 6, wherein the vent is disposed in the recirculation conduit.

8. The engine as set forth in claim 1, comprising an EGR line connected at one end to the engine exhaust and connected at another end to the conduit downstream from the recirculation conduit.

9. The engine as set forth in claim 1, comprising an EGR line connected at one end to the engine exhaust and connected at another end to the conduit downstream from the recirculation conduit, the EGR line including an EGR valve, the monitor sending a signal to the controller to open and close the EGR valve to adjust emissions characteristics.

10. The engine as set forth in claim 1, comprising a fuel injector arranged to inject fuel at the engine intake and a controller arranged to control opening and closing of the valve to adjust an air-fuel ratio at the engine intake.

11. The engine as set forth in claim 10, comprising an EGR line connected at one end to the engine exhaust and connected at another end to the conduit downstream from the recirculation conduit, the EGR line including an EGR valve, the monitor sending a signal to the controller to open and close the EGR valve to adjust emissions characteristics.

12. A method for controlling exhaust characteristics of an engine, comprising:
compressing charge air in a compressor;
recirculating compressed gas from an outlet of the compressor to an inlet of the compressor such that the compressed gas from the outlet of the compressor comprises a mixture of charge air and recirculated compressed gas;
opening and closing a valve to control recirculation of the compressed gas;
supplying the compressed gas to an engine intake; and
adjusting emissions characteristics at an exhaust of the engine by controlling recirculation of the compressed gas.

13. The method as set forth in claim 12, comprising adjusting emissions characteristics by controlling EGR flow through an EGR line to the engine intake.

14. The method as set forth in claim 12, comprising controlling a ratio of charge air and recirculated compressed gas in the compressor.

15. The method as set forth in claim 12, comprising injecting fuel at the engine intake and adjusting an air-fuel ratio at the intake by controlling recirculation of the compressed gas.

16. The method as set forth in claim 15, comprising adjusting the air-fuel ratio by controlling EGR flow through an EGR line to the engine intake.
